(19) United States
(12) Patent Application Publication
(10) Pub. No.: US 2010/0138765 A1
(43) Pub. Date: Jun. 3, 2010

(54) Indicator Pop-Up

(75) Inventor: Roope Rainisto, Helsinki (FI)

Correspondence Address: Perman & Green, LLP, 99 Hawley Lane, Stratford, CT, 06614, US

(73) Assignee: Nokia Corporation, Espoo (FI)

(21) Appl. No.: 12/325,211

(22) Filed: Nov. 30, 2008

(51) Int. Cl. G06F 3/048

(52) U.S. Cl. 715/766; 715/762; 715/808

(57) ABSTRACT

An apparatus includes a display, an processor configured to allow for selecting items of interest for inclusion in an indicator pop-up, circuitry configured for maintaining the indicator pop-up for continued use when performing other actions, and an indicator configured for selecting the indicator pop-up to be shown on the display.

### BACKGROUND

1. Field

The disclosed embodiments generally relate to user interfaces and, more particularly, to a pop-up on a user interface.

2. Brief Description of Related Developments

A computing device, for example, a portable appliance, communication device, personal digital assistant, etc. may display an individual event pop-up for each event as it occurs while the device is idle. A pop-up is generally a window, or a section of a user interface, that appears in the foreground of the user interface. A pop-up may include additional or supplemental information or menu choices and is generally smaller that the background of the user interface.

Generally, if a user operates the computing device, the individual event pop-up is eliminated and the relevant task or information is relegated somewhere within the menu structure of the device. When another event occurs, another pop-up specific for the new event may be generated. In some devices, when events of the same type occur, a pop-up is generated that lists the events of the same type. However, there is no know way to obtain a pop-up that includes a consolidated grouping of all types of events or items of interest at the same time. Furthermore, even in the case of the pop-up that includes events of the same type, if the user performs another unrelated operation, the pop-up is generally torn down and the tasks are distributed within the menu structure.

In other instances, a user may populate the idle screen with information of interest, for example, status of downloads, shortcuts, WLAN activity, etc. The idle screen may also be used to collect notifications and incomplete tasks. Occasionally, the idle screen may become cluttered, it may become hard to distinguish among the displayed items, and the background image may be obscured. The clutter may be aggravated because devices are becoming smaller and more portable devices and tend to have relatively small displays. Both portable and non-portable devices may exhibit these problems related to event pop-ups that are eliminated and items that clutter the idle screen.

It would be advantageous to provide upon demand, a consolidated group of information of interest to a user, for example, tasks, task status, recent events, missed events, messages, etc., that is not eliminated or torn down if interrupted by a user, that is readily available, and that reduces visual clutter in an apparatus.

### SUMMARY

The following summary is intended to exemplary only and non-limiting.

In one aspect, the disclosed embodiments are directed to an apparatus having a display, a processor configured to allow for selecting items of interest for inclusion in an indicator pop-up, circuitry configured for maintaining the indicator pop-up for continued use when performing other actions, and an indicator configured for selecting the indicator pop-up to be shown on the display.

In another aspect, the disclosed embodiments are directed to a method including selecting items of interest for inclusion in an indicator pop-up to be displayed on a device, selecting the indicator pop-up for display by activating an indicator displayed on the device, and maintaining the indicator pop-up for continued use when using the device to perform other actions.

In yet another aspect, the disclosed embodiments are directed to a computer readable medium encoded with computer readable program code, which when executed causes a computer to allow for selecting items of interest for inclusion in an indicator pop-up to be shown on a display of a an apparatus, maintain the indicator pop-up for continued use while the apparatus is used to perform other actions, and re-display the indicator pop-up for display upon activation of an indicator.

Other aspects and embodiments are also contemplated.

### BRIEF DESCRIPTION OF THE DRAWINGS

The foregoing aspects and other features of the embodiments are explained in the following description, taken in connection with the accompanying drawings, wherein:

FIG. 1 shows an exemplary apparatus 100 for practicing the disclosed embodiments;

FIGS. 2A and 2B show examples of different orientations for the exemplary apparatus 100;

FIG. 3 shows an exemplary selection menu or pop-up for selecting items of interest;

FIG. 4A shows an exemplary indicator pop-up according to the disclosed embodiments;

FIG. 4B illustrates a flow diagram of a process in accordance with the disclosed embodiments;

FIGS. 5A and 5B are illustrations of examples of devices that may be used to practice aspects of the disclosed embodiments;

FIG. 6 illustrates a block diagram of an exemplary system incorporating features that may be used to practice the disclosed embodiments; and

FIG. 7 shows a block diagram illustrating the general architecture of an exemplary system in which the exemplary devices of FIGS. 5A and 5B may be used.

### DETAILED DESCRIPTION OF THE EMBODIMENTS

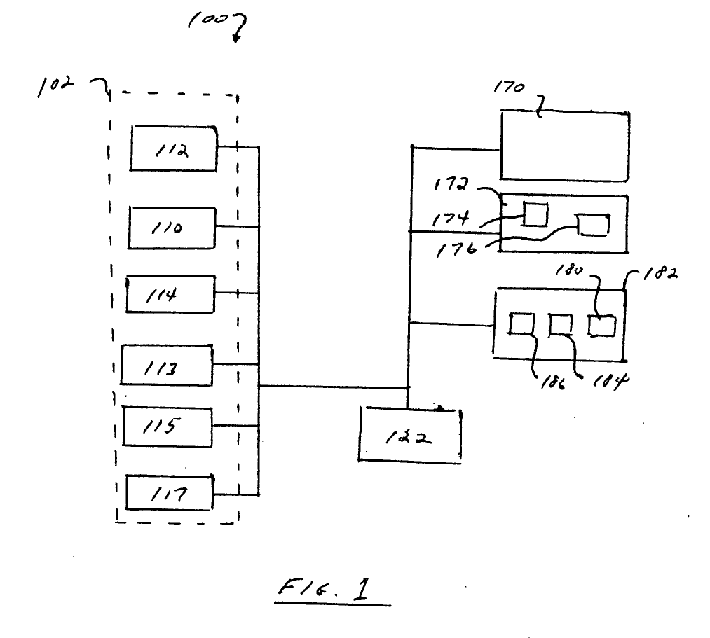

FIG. 1 illustrates one embodiment of an exemplary apparatus 100 in which aspects of the disclosed embodiments may be applied. Although aspects of the disclosed embodiments will be described with reference to the embodiments shown in the drawings and described below, it should be understood that these aspects could be embodied in many alternate forms and in any possible combination of elements. In addition, any suitable size, shape or type of elements or materials could be used.

The disclosed embodiments may generally incorporate a portion of a user interface that provides, upon demand, a consolidated group of additional information, additional tasks, tasks to be performed, the status of ongoing tasks, recent events, missed events, or any information that a user may find of interest. For example, in one embodiment, a pop-up may be provided by pressing an indicator. The pop-up may include recent events, missed events, download status of currently ongoing downloads, updates to favorite web pages, WLAN activity, etc. The pop-up is not eliminated or destroyed if the user interrupts the actions taken with regard to the pop-up and the pop-up is always available or may be re-activated by pressing an indicator on the user interface.

FIG. 1 shows an exemplary apparatus 100 for practicing the disclosed embodiments. Apparatus 100 may be a portable device, for example, a mobile communications terminal, or may be a fixed device, for example, a terminal at a kiosk or a fixed communications terminal. Apparatus 100 may be any suitable device, provided it is capable of allocating a portion of its user interface for the embodiments described herein. Apparatus 100 may include a user interface 102, a processor 122 and a storage device 182. Apparatus 100 may also include a communications function 170, and a location function 172.

The user interface 102 of the disclosed embodiments may include input and output devices for interaction with one or more users. User interface 102 may include both touch and non-touch devices. Touch devices may include a touch screen or proximity screen device 112 which may be responsive to user input and may also include a display. In alternate embodiments, the aspects of the user interface 102 disclosed herein may be embodied on any suitable device that will display information and allow the selection and activation of applications, system content, and the functions of the embodiments described herein. The terms “select” and “touch” are generally described with respect to a touch screen-display. However, in alternate embodiments, the terms are also intended to encompass required user action with respect to other input devices. For example, with respect to the touch/proximity screen device 112, it may not be necessary for a user to make direct contact with the touch/proximity screen device 112 in order to select an object, other information, or to initiate an application.

Thus, the above noted terms are intended to encompass a user only being within a proximity of touch/proximity screen device 112 to carry out the desired function. For example, the term “touch” in the context of the touch/proximity screen device 112, does not necessarily require direct contact, but may include near or close contact that activates the touch/proximity screen device 112. Similarly, the scope of the intended devices is not limited to single touch or contact devices.

Examples of single and multi-touch operations may include a touchdown, where a user touches a particular part of the a screen of the touch/proximity screen device 112, a touch release, where a user ends contact with the touch/proximity screen 112, a move, where the user touches the touch/proximity screen 112 and moves while maintaining contact with the screen, a pinch, where the user touches the touch/proximity screen device 112 in two points and “drags” the two points together or apart, and a rotation, where the user touches the touch/proximity screen device 112 in two points and rotates the points. Any operations where contact by one or more fingers or other pointing devices can navigate on and about the screen are also intended to be encompassed by the disclosed embodiments.

Non-touch devices 117 are also intended to be encompassed by the disclosed embodiments. Non-touch devices may include, but are not limited to, brain computer interfaces (BCI) and devices without touch or proximity screens. In one embodiment, with non-touch devices such as BCI a user may use thoughts to control the devices described herein (i.e. through neuro-physiological signals detected from the brain or from other suitable nervous tissue).

The user interface 102 may also include keys 110, for example, hard keys, soft keys, a keyboard, etc. for receiving user input, and a microphone 113 for receiving voice commands. The user interface 102 may also include a tactile response device 115, for example, a vibrator, or other device that provides tactile feedback to the user as a user performs a non-touch, touch or multi-touch operation. For example, the tactile response device 115 may be built into the display and may cause a “press back” in the area touched by the user. In other examples, the tactile response device 115 may simply vibrate or may provide any other form of tactile response that presents a user with an indication that an input has been recognized.

The user interface 102 may also include one or more displays 114 which, as mentioned above, may be part of touch/proximity screen 112, or may be separate devices. The one or more displays generally provide information to a user including menus for selecting functions of the apparatus 100.

Still referring to FIG. 1, the processor 122 operates to control the functions of the apparatus 100. The processor may receive inputs, for example, signals, transmissions, instructions or commands related to the functions of the device 100 from user interface 102, storage device 182, and communications function 170. The processor 122 interprets the inputs and controls the functions of the apparatus 100 accordingly. In some embodiments, the processor 122 receives inputs from the user interface 102 related to selecting icons on the display 114, navigating menu structures, or otherwise making selections and initiating applications. In response, the processor 122 displays desired items on the display 114 and runs the requested applications. In particular, the processor may receive user input related to selecting items for an indicator pop-up and operations related to displaying, utilizing, hiding, and restoring the indicator pop-up as will be described below.

Storage device 182 generally includes instructions or commands for the processor 122 related to the functions of the apparatus 100. Storage device 182 includes computer readable media encoded with computer executable components, software, programs, instructions, commands, etc. for implementing the embodiments disclosed herein, in particular, operations related to selecting items and events for an indicator pop-up, and operations related to detecting the items or events, adding them to the pop-up, and displaying, utilizing, hiding, and restoring the indicator pop-up. Storage device 182 may utilize optical, magnetic, chemical, electrical, or any other suitable properties for receiving, storing, or delivering instructions and commands. Storage device 182 may include magnetic media, such as a diskette, disk, memory stick or computer hard drive, which is readable and executable by a computer. In other embodiments, storage device 182 may include optical disks, read-only-memory (“ROM”) floppy disks and semiconductor materials and chips. Storage device 182 may generally utilize any suitable technology for implementing the embodiments disclosed herein.

Storage device 182 may also include applications 180 and application settings 184 for other functions, for example, data acquisition (e.g. image, video and sound), data processing (spread sheets, word processor, contact lists, currency converters, etc.), multimedia players (e.g. video and music players), various web services, and any other suitable applications. Storage device 182 may also include one or more databases 186 that include data, maps, contact information, or other information.

Communications function 170 may include circuitry and programs for providing any suitable communications tasks for implementing the disclosed embodiments. Communications function may include facilities for any type of satellite, mobile, wireless, wide area network, local area network, or public switched telephone network communications, or any other suitable communication facilities.

Location function 172 may generally include circuitry and programs for determining the location, orientation, and forces being applied to the apparatus 100. For example, location function 172 may include a global positioning system processor 174, a compass, one or more accelerometers, and any other suitable sensors referred to collectively as sensors 176. As a further example, apparatus 100 may use the global positioning system processor 174 to determine its own location.

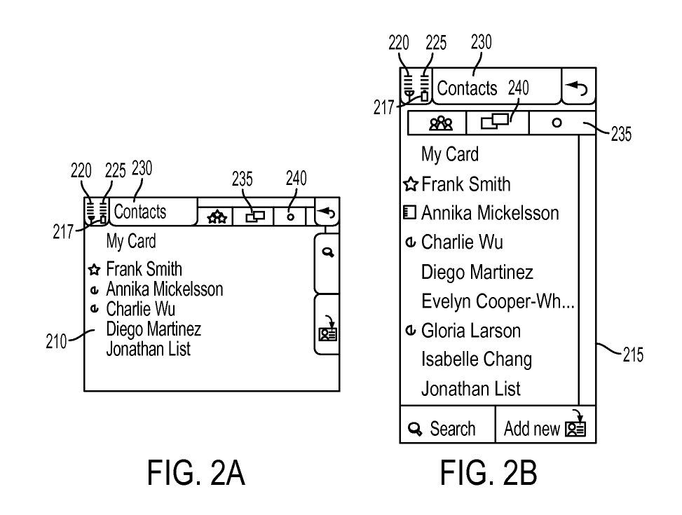

FIGS. 2A and 2B show examples of different orientations and associated display configurations or layouts for the apparatus 100. By utilizing the sensors, and optionally applications 180 and application settings 184, the apparatus 100 may determine its own orientation, for example, horizontal landscape, as shown in FIG. 2A, or vertical portrait, as shown in FIG. 2B. Other orientations of the apparatus 100 may also be determined. Moving the apparatus 100 from one orientation to another may be referred to as a gesture. Each of the display configurations 210, 215 may include a universal indicator 217, including for example, a signal strength 220 and battery life indicator 225, a status pane 230 with a title specific to the contents of the particular portion of the display, and a navigation pane 235. In some embodiments, the navigation pane may include one or more tabs 240 for displaying different features of the information in the display configurations 210, 215. Each of the signal strength 220 and battery life indicators 225, status pane 230, and navigation pane 235 may be abbreviated or expanded as the space for these features changes with the different orientations. In some embodiments, the universal indicator 217, which may include the signal strength 220 and battery life indicators 225, may be displayed in every display configuration and may also be displayed at a consistent location within particular display configurations.

According to the disclosed embodiments, an indicator pop-up may be displayed that includes a consolidated list of items of interest to the user, including, for example, additional information, additional tasks, the status of ongoing tasks, recent events, missed events, or any other information of interest.

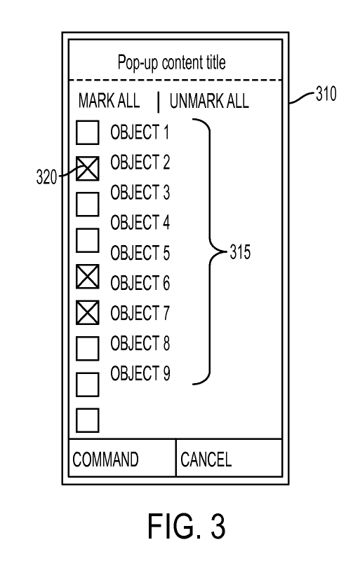

In some embodiments, the user may select the items of interest for the indicator pop-up. Referring to exemplary FIG. 3, a user may select an icon or navigate through a menu structure under the guidance or direction of processor 122 (FIG. 1) to obtain a selection menu or selection popup 310 on display 114. Each of the available items of interest 315 that may be selected for inclusion in an indicator pop-up may be displayed in the selection menu or pop-up 310. A user may select items for inclusion by using, for example, a check box 320 or other selection mechanism as appropriate. Once selections have been made, the selections may be saved, for example, in storage area 182 (FIG. 1). In other embodiments, the items of interest may be provided as default selections from the factory, according to regional preferences, or by using any other suitable criteria.

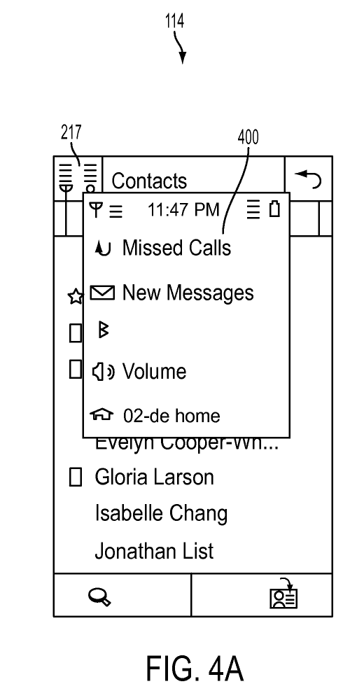

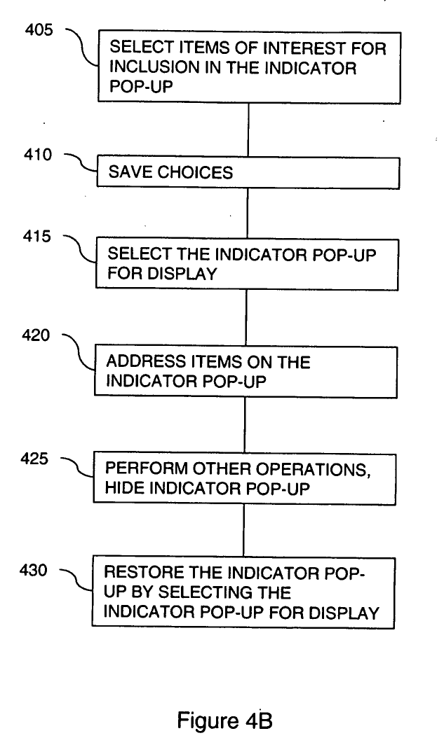

An exemplary indicator pop-up 400 in accordance with the disclosed embodiments is shown in FIG. 4A. As mentioned above, the indicator pop-up 400 may include recent events, missed events, the download status of currently ongoing downloads, updates to favorite web pages, WLAN activity, or any other information of interest to the user. The indicator pop-up 400 may be displayed by various methods, including making a selection by, for example, selecting an icon, navigating a menu structure, pressing a particular hard or soft key or key combination, or by other suitable actions. The pop-up 400 may be referred to as an “indicator” pop-up because in some embodiments, the indicator pop-up 400 is displayed by activating or selecting an indicator on the display 114, for example, the universal indicator 217 on the display 114. The selection may be made, for example, by “tapping” the universal indicator 217, that is, performing a touch down and touch release within a relatively short period of time, typically on the order of seconds or fractions of a second. In at least one embodiment, the indicator pop-up 400 may be automatically displayed upon the processor 122 (FIG. 1) detecting an event related to an item of interest selected by a user from the selection menu or pop-up 310 (FIG. 3).

Once the indicator pop-up 400 “pops up” or is displayed, a user may address the items listed thereon. The user may optionally cause an addressed item to be removed, for example, by tapping the addressed item or by otherwise indicating that the item is to be removed. In some embodiments, items that have been addressed may be removed automatically. Items that are in process, are for general information, or that a user wishes to retain may remain in the indicator pop-up 400, either indefinitely or until removed by the user. For example, a user may wish to retain the status of a download in process in the indicator pop-up. Thus, the indicator pop-up 400 shows a consolidated list of items of interest to the user including, as desired, missed events, upcoming events, and items that may need a user's attention. If user decides to perform actions other than addressing the items in the indicator pop-up while the indicator pop-up is displayed, circuitry, for example, processor 122 in combination with programs in storage device 182, operates to maintain the indicator pop-up and ensure the pop-up remains available. For example, if instead of addressing items displayed in the indicator pop-up 400, or while addressing the items, the user places a call, the indicator pop-up 400 may be removed from the display, but may be redisplayed by re-selecting the indicator pop-up, for example, by tapping the universal indicator 217. Thus, the indicator pop-up is not destroyed or torn down, but remains available for continued use.

The items of interest displayed in the indicator pop-up 400 may include items that might normally be displayed on the idle screen of the apparatus 100. Some examples, without limitation, include one or more of indications that a memory card is inserted, that a headset is connected, of volume level, of the progress of a download, or of the progress of media playback, all of which may be presented in the indicator pop-up 400. Any other suitable indication that would otherwise appear on the idle screen may be displayed in the indicator pop-up 400.

Thus, the indicator pop-up 400 provides a consolidated list of items of interest to the user in a single place. The indicator pop-up remains available during other actions by pressing another indicator, and provides an alternate to displaying items on the idle screen, resulting in reduced clutter.

FIG. 4B illustrates a flow diagram of a process in accordance with the disclosed embodiments. In block 405, items of interest may be selected for inclusion in the indicator pop-up. In block 410, the choices may be saved, for example in storage device 182 (FIG. 1). In block 415, if an event related to a selected item is detected, the indicator pop-up may optionally be displayed automatically. In block 420, in the event that the indicator pop-up has not been displayed automatically, it may be selected for display, for example, by tapping the universal indicator 217 (FIG. 2). In block 425, the user may address the items on the indicator pop-up and in block 430, if the user performs other operations, for example placing a call, the indicator pop-up may be hidden or removed from the display. As mentioned above, the user may perform the other operations instead of addressing the items in the indicator pop-up. In block 435, the indicator pop-up may be restored by selecting the indicator pop-up for display, for example, by again tapping the universal indicator 217.

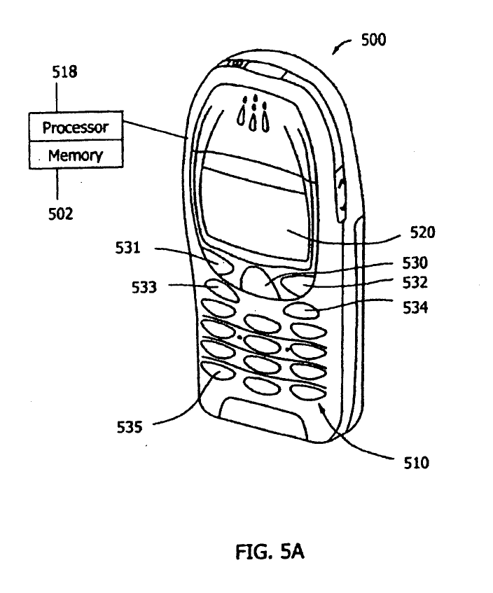

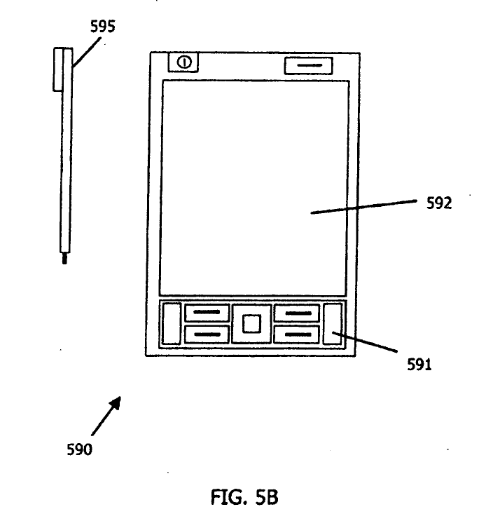

Examples of devices on which aspects of the disclosed embodiments can be practiced are illustrated with respect to FIGS. 5A and 5B. A terminal or mobile communications device 500 may incorporate all the functions of an augmented reality display device as described above. The terminal or mobile communications device 500 have a keypad 510 and a display 520. The keypad 510 may include any suitable user input devices such as, for example, a multi-function/scroll key 530, soft keys 531, 532, a call key 533, an end call key 534 and alphanumeric keys 535. The display 520 may be any suitable display, such as for example, a touch screen display or graphical user interface. The display may be integral to the device 500 or the display may be a peripheral display connected to the device 500. A pointing device, such as for example, a stylus, pen or simply the user's finger may be used with the display 520. In alternate embodiments any suitable pointing device may be used. In other alternate embodiments, the display may be for example a flat display that is typically made of an liquid crystal display (LCD) with optional back lighting, such as a thin film transistor (TFT) matrix capable of displaying color images. In still other alternate embodiments, the display may be any suitable conventional display.

The device 500 may also include other suitable features such as, for example, a camera, loud speaker, connectivity port or tactile feedback features. The mobile communications device may have a processor 518 connected to the display for processing user inputs, displaying information on the display 520, and for controlling the terminal or mobile communications device 500 according to the augmented reality display embodiments described herein. A memory 502 may be connected to the processor 518 for storing any suitable information and/or applications associated with the mobile communications device 500 such as phone book entries, calendar entries, instructions or commands related to the functions of displaying augmented reality disclosed herein, etc. Memory 502 may include computer readable media encoded with computer executable components software, programs, instructions, commands, etc. for implementing the embodiments disclosed herein.

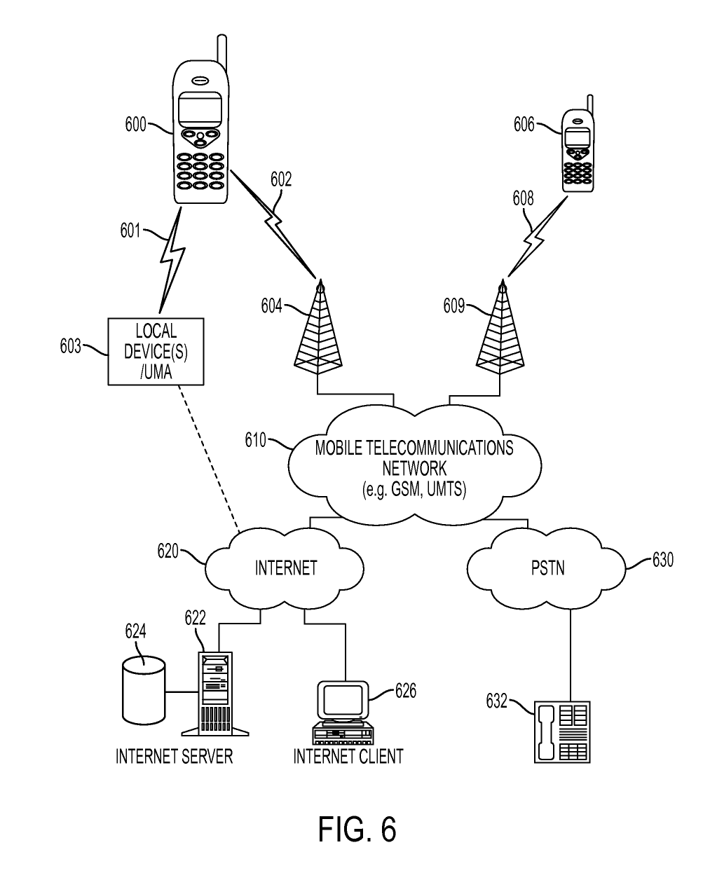

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between a mobile terminal 600 and other devices, such as another mobile terminal 606, a line telephone 632, a personal computer 626 and/or an internet server 622.

The mobile terminal 600 generally includes all the features of terminal or mobile communications device 500 and apparatus 100. It is to be noted that for different embodiments of the mobile terminal 600 and in different situations, some of the telecommunications services indicated above may or may not be available. The aspects of the disclosed embodiments are not limited to any particular set of services in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. An Internet server 622 has data storage 624 and is connected to the wide area network 620, as is an Internet client computer 626. In some embodiments, data storage 624 may include applications for implementing the functions related to selecting items for an indicator pop-up, and displaying, utilizing, hiding, and restoring the indicator pop-up as described above.

The server 622 may host a worldwide web/wireless application protocol server capable of serving worldwide web/wireless application protocol content to the mobile terminal 600. A public switched telephone network (PSTN) 630 may be connected to the mobile telecommunications network 610 in a familiar manner. Various telephone terminals, including the stationary telephone 632, may be connected to the public switched telephone network 630.

The mobile terminal 600 is also capable of communicating locally via a local link 601 to one or more local devices 603. The local link 601 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 603 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the processor 122 of FIG. 1 and the communications function 170 may be configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the apparatus 100 of FIG. 1 may be implemented in, for example, a personal digital assistant (PDA) style device 590 illustrated in FIG. 5B. The personal digital assistant 590 may have a keypad 591, a touch screen display 592 and a pointing device 595 for use on the touch screen display 592. In still other alternate embodiments, the device may be a personal computer, a tablet computer, touch pad device, Internet tablet, a laptop or desktop computer, a mobile terminal, a cellular/mobile phone, a multimedia device, a personal communicator, or any other suitable device capable of containing, for example, a display 114 shown in FIG. 1, and supported electronics such as the processor 122 and memory 182.

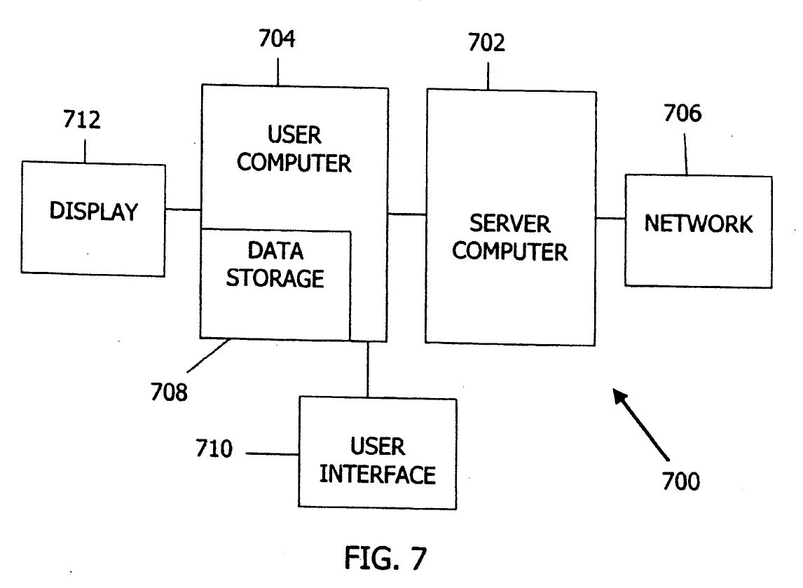

The disclosed embodiments may also include software and computer programs incorporating the process steps and instructions described above that are executed in different computers. FIG. 7 is a block diagram of one embodiment of a typical apparatus 700 incorporating features that may be used to practice aspects of the disclosed embodiments. The apparatus 700 can include a computer readable media with computer executable components or program code embodied therein for implementing the disclosed embodiments. As shown, a computer system 702 may be linked to another computer system 704, such that the computers 702 and 704 are capable of sending information to each other and receiving information from each other. Computer 704 generally includes all the features of apparatus 100.

In one embodiment, computer system 702 could include a server computer adapted to communicate with a network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on an integrated services digital network (ISDN) line. Computers 702 and 704 are generally adapted to utilize program storage devices with computer readable media embodying computer executable components, for example, machine-readable program source code, which is adapted to cause the computers 702 and 704 to implement the embodiments disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 704 may include a data storage device 708 on its program storage device for the storage of information and data. The computer program or software implementing the disclosed embodiments may be stored in one or more computers 702 and 704 on an otherwise conventional program storage device. In one embodiment, computers 702 and 704 may include a user interface 710, and a display interface 712 from which aspects of the disclosed embodiments may be accessed. The user interface 710 and the display interface 712 may be adapted to allow the input of queries and commands to the system, as well as present the results of the commands and queries.

The exemplary embodiments described herein are provided as non-limiting examples of selecting items of interest for inclusion in an indicator pop-up, optionally displaying the indicator pop-up if an event related to a selected item is detected, selecting the indicator pop-up for display by activating an indicator, and maintaining the indicator pop-up for continued use when performing other actions.

It is noted that the embodiments described herein may be used individually or in any combination thereof. It should be understood that the foregoing description is only illustrative of the embodiments. Various alternatives and modifications may be devised by those skilled in the art without departing from the embodiments. Accordingly, the present embodiments are intended to embrace all such alternatives, modifications and variances that fall within the scope of the disclosure.

What is claimed is:

1. An apparatus comprising:
a display;
a processor configured to allow for selecting items of interest for inclusion in an indicator pop-up;
circuitry configured for maintaining the indicator pop-up for continued use when performing other actions; and
an indicator configured for selecting the indicator pop-up to be shown on the display.

2. The apparatus of claim 1, further comprising a processor configured for displaying the indicator pop-up upon determining the occurrence of an event related to one or more of the selected items.

3. The apparatus of claim 1, further comprising circuitry configured for hiding the pop-up while a user performs the other actions and for restoring the pop-up upon activation of the indicator.

4. The apparatus of claim 1, wherein the indicator pop-up includes one or more of: tasks to be performed, a status of ongoing tasks, recent events, missed events, a download status of currently ongoing downloads, updates to one or more web pages, and WLAN activity.

5. The apparatus of claim 1, wherein the indicator pop-up includes one or more items previously displayed on an idle screen of the apparatus.

6. A method comprising:
selecting items of interest for inclusion in an indicator pop-up to be displayed on a device;
selecting the indicator pop-up for display by activating an indicator displayed on the device; and
maintaining the indicator pop-up for continued use when using the device to perform other actions.

7. The method of claim 6, further comprising displaying the pop-up upon occurrence of an event related to one or more of the selected items.

8. The method of claim 6, further comprising hiding the pop-up while performing the other actions and restoring the pop-up by re-activating the indicator.

9. The method of claim 6, further comprising including on the indicator pop-up, one or more of: tasks to be performed, a status of ongoing tasks, recent events, missed events, a download status of currently ongoing downloads, updates to one or more web pages, and WLAN activity.

10. The method of claim 6, further comprising including on the indicator pop-up, one or more items previously displayed on an idle screen of the apparatus.

11. A computer readable medium encoded with computer readable program code, which when executed causes a computer to:
allow for selecting items of interest for inclusion in an indicator pop-up to be shown on a display of a an apparatus;
maintain the indicator pop-up for continued use while the apparatus is used to perform other actions; and
re-display the indicator pop-up for display upon activation of an indicator.

12. The computer readable medium of claim 11, further comprising computer readable program code for displaying the indicator pop-up upon determining the occurrence of an event related to one or more of the selected items.

13. The computer readable medium of claim 11, further comprising computer readable program code for hiding the pop-up while a user performs the other actions and for restoring the pop-up upon re-activation of the indicator.
